(19) United States
(12) Patent Application Publication
(10) Pub. No.: US 2018/0116361 A1
(43) Pub. Date: May 3, 2018

(54) MULTIFUNCTIONAL SMART LUGGAGE CARRIER

(71) Applicant: Universal Travel Systems Inc., Edmonton (CA)

(72) Inventors: Samar Anjum, Edmonton (CA); Navniit Ssharma, New Delhi (IN); Sanandan Sudhir, Ahmedabad (IN)

(21) Appl. No.: 15/802,076

(22) Filed: Nov. 2, 2017

Related U.S. Application Data
(60) Provisional application No. 62/416,745, filed on Nov. 3, 2016.

(51) Int. Cl. A45C 15/06; A45C 5/03; A45C 13/00; A45C 5/14; A45C 13/18; A45C 13/26; H02J 7/00; G01G 19/58

(52) U.S. Cl. CPC A45C 15/06; A45C 5/03; A45C 13/005; A45C 5/146; A45C 13/18; H02J 2007/0062; A45C 13/001; H02J 7/0052; G01G 19/58; A45C 2013/267; A45C 2200/10; A45C 13/262

(57) ABSTRACT

Embodiments of the present disclosure relate to a multifunctional smart luggage carrier include a body defining an enclosure and having at least one opening. The luggage carrier may include an automatic telescopic retractable handle, retractable wheels, and automatic lifting mechanism for easy carrying and moving or easily transfer the luggage carrier. The luggage carrier may also include a processor, a wireless receiver, electronically controllable lock, and virtual tag (for exchange real time info for e.g., flight or train times, departure gates, weather and weight of the suitcase), built in tracking system (for tracking the Luggage carrier during travelling), weigh scale and location sensor for detecting location of luggage carrier.

This application claims priority to U.S. Patent Appln. No. 62/416,745 filed Nov. 3, 2016, which is hereby incorporated by reference.

### TECHNICAL FIELD

The present invention relates to the field of luggage carriers. More specifically, it pertains to an improved multifunctional smart luggage carrier that enables a user to operate its features using a Smart Phone.

### BACKGROUND

Background description includes information that may be useful in understanding the present invention. It is not an admission that any of the information provided herein is prior art or relevant to the presently claimed invention, or that any publication specifically or implicitly referenced is prior art.

Almost everyone is required to travel between locations for work and/or pleasure. Various items of personal use are being needed during the travel and accordingly need of luggage bags (or carriers) to pack and carry them in a convenient manner. Portable luggage bags are well known in the arts, some of which are carried by hand and others may have wheels. These carriers generally incorporate a base equipped with wheels and telescopic handles for carrying luggage from one place to another place with ease. Though the wheeled luggage is very convenient, it does not solve problems associated with the luggage carrying, transporting and managing them.

Prior art references like US Patent numbers U.S. Pat. No. 5,645,146, U.S. Pat. No. 9,119,453, U.S. Pat. No. 9,241,554 and others disclose carrying handles for luggage to meet requirement of manually lifting the luggage which is a common practice. Suitcase or luggage carrier is usually full with items making it heavy, and therefore it may sometimes be difficult to lift them, more so for aged people, Children, Pregnant Ladies. In some cases, user may have more than one item to carry for example gadgets, Hand Bag etc. In such situation it would be difficult for him to lift suitcase or luggage carrier.

Prior art references like US Patent numbers U.S. Pat. No. 5,531,300, U.S. Pat. No. 5,694,663 & others disclose luggage with Retractable handles that are manually operated. They involve manual pushing and pulling of telescopic handle rods resulting in difficulty because sometimes these telescopic rods get stuck increasing user's effort.

There is other type of luggage carrier having a telescopic handle assembly and a pair of rotatable wheels provided at end opposite the one having the handle assembly. However, the wheels always protrude from the luggage Carrier leading to their getting damaged due to mishandling. It is common for the luggage carriers to be thrown around during transit at airports, so durability of the wheels of the suitcase or luggage carrier is an issue.

Besides above, other problems are also faced by user during travelling with luggage carrier. For example, unplanned excess weight that can result in extra cost during air travel, locating contents in the dark when user is travelling in trains or by other mode of transport in night to name a few. Such issues may throw up challenges of unpacking an entire bag while locating specific items from inside the luggage carrier. Further, suitcase or luggage carrier's locks often get stuck and damaged while opening and closing.

There are other challenges faced by travellers that are not directly related to luggage. For example, struggle associated with accessing flight information (i.e., flight's departure and arrival time, airport terminal and gate) and retrieving local weather report from airport screens and televisions. Further, there is a risk of personal data being compromised from passports and credit cards while in transit.

There is therefore a need for smart, durable, automatic, multifunctional, reliable & user-friendly luggage carrier that caters to above mentioned multifaceted challenges faced by a traveller.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### OBJECTS OF THE INVENTION

A general object of the present disclosure is to provide a smart, durable, automatic, multifunctional, reliable & user-friendly luggage carrier.

An object of the present disclosure is to provide a luggage carrier having automatic retractable wheels, telescopic handle & automatic lifting mechanism for user comfort.

Another object of the present disclosure is to provide a luggage carrier that integrates smart systems like in built weigh scale, a virtual tag or display, luggage tracking system, remotely lock & unlock arrangement and proximity indication.

Yet another object of the present disclosure is to provide a radio frequency identification enabled pocket for holding personal items, such as passport and credit cards, which blocks any potential identity theft.

Still another object of the present disclosure is to provide a feature for LED light system that lights up interior or exterior of the suitcase or luggage carrier.

Still another object of the present disclosure is to provide an in-built power storage & power supply system for charging external & internal electronic devices.

Still another object of the present disclosure is to provide a smart system which enables user to switch the mode of operation like manual mode (sleep mode) to automatic mode & vice versa.

### SUMMARY

Aspects of the present disclosure relate to a smart luggage carrier that comprises a main module having a partition wall, the partition wall dividing the main module between a front side compartment and a back side compartment; a front cover fixed to the main module in hinged manner on the side of the front side compartment; and a back cover fixed to the main module in hinged manner on the side of the back side compartment. The disclosed luggage carrier also includes a plurality of wheels that support the luggage carrier and enable movement of the luggage carrier. In an aspect, the luggage carrier further includes a wireless communication module to establish wireless communication with an external electronic device, wherein the wireless communication between the luggage carrier and the connected external device provides additional functionalities to the luggage carrier.

In an aspect, additional functionalities provided by the wireless communication is at least one of location tracking, automatic retraction and deployment of wheels, communicating weight of the luggage carrier, issuing a warning when distance between the luggage carrier and the external device exceeds a predefined limit, telescopic handle up down movements, operation of locks, LED lights ON and OFF.

In an aspect, external electronic device is any one of a smart mobile phone, a tablet or a desktop computing device, and wherein the additional functionalities are made operational by syncing the luggage carrier with an application on the external electronic device.

In an aspect, the disclosed luggage carrier includes a microcontroller and associated electronic circuit that includes the wireless communication module, and wherein the microcontroller and the electronic circuit works to operationalize the various functionalities.

In an aspect, the disclosed luggage carrier further includes a power storage and supply system to meet power requirement of the microcontroller and the electronic circuit, and of different functional requirements; and wherein the power storage and supply system includes a rechargeable power bank or a storage battery, and further includes at least one USB port for getting input power for recharging the rechargeable power bank or the storage battery, and supplying power for charging of other electronic devices.

In an aspect, plurality of wheels are retractable within the luggage carrier to prevent damage due to rough handling, and the luggage carrier includes a motorized retraction mechanism coupled to the plurality of wheels to automatically retract them, and wherein the retraction mechanism is adapted for operation using the external electronic device. The motor of the motorized retraction mechanism for the retractable wheels gets electric power from the rechargeable power bank or the storage battery, and its operation command from the synced external electronic device through the electronic circuit.

In an aspect, luggage carrier includes a weight sensor fitted between the main module and a handle, and wherein weight of the luggage carrier as sensed by the weight sensor is displayed on a display on the main module, and in addition communicated to the external electronic device based on user choice.

In an aspect, luggage carrier includes a retractable handle and a motorized mechanism to move the retractable handle between a retracted position and an extended position, and wherein the motorized mechanism for the retractable handle is adapted for actuation using the external electronic device. The retractable handle can be located adjacent to the partition in the main module either in the front side compartment or the back side compartment to enable user to carry the luggage carrier from either side.

In an aspect, luggage carrier includes solenoid locks to lock the front cover and the back cover with the main module, and wherein the solenoid locks are adapted for operation through the external electronic device.

In an aspect, luggage carrier includes a location tracking module adapted to ascertain location coordinates of the luggage carrier based on a request from a user through the external electronic device, and wherein the ascertained location coordinates are communicated to the external electronic device using the communication module.

In an aspect, luggage carrier includes a proximity sensor adapted to sense distance between the luggage carrier and the external electronic device, and wherein in the event of the sensed distance exceeding a predefined distance a warning is issued.

In an aspect, the luggage carrier includes orientation sensors to sense orientation of the luggage carrier, wherein the orientation sensors are at least one of a magnetometer, an accelerometer and a gyroscope, and wherein the sensed orientation is displayed on the display or the external electronic device.

In an aspect, the luggage carrier further includes an atmospheric pressure sensor to sense the atmospheric pressure, wherein the sensed atmospheric pressure is used to ascertain altitude, and when the ascertained altitude is more than a first predefined value it is ascertained that the luggage carrier is in a flight, and the electronic circuit is put to sleep mode.

In an aspect, when the ascertained altitude is less than a second predefined value it is ascertained that the flight is landing, and the electronic circuit is put to active mode.

In an aspect, the front cover includes a switchable film to enable viewing of contents within at least a part of the luggage carrier by making the switchable film transparent.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1A illustrates exemplary rear and front perspective views of the disclosed smart luggage carrier in closed condition showing main outer body configuration in accordance with embodiments of the present disclosure.

FIG. 1B illustrates exemplary rear and front perspective views of the disclosed smart luggage carrier in opened condition showing main inner body configuration in accordance with embodiments of the present disclosure.

FIG. 1C illustrates an exemplary representation of the disclosed luggage carrier communicating with an external electronics device through a wireless communication module in accordance with embodiments of the present disclosure.

FIG. 1D illustrates an exemplary block diagram showing layout of electronics part of the disclosed smart luggage carrier in accordance with embodiments of the present disclosure.

FIGS. 2A and 2B illustrate exemplary perspective views of main module of smart luggage carrier from different angles in accordance with embodiments of the present disclosure.

FIG. 3A illustrates an exemplary perspective view and exploded view of the smart luggage carrier showing assembly of front cover with main module in accordance with an embodiment of the present disclosure.

FIG. 3B illustrates an exemplary perspective view showing assembly of front cover and PDLC film in accordance with embodiments of the present disclosure.

FIGS. 4A and 4B illustrate exemplary perspective views of laptop tray assembly and its assembly with main module respectively in accordance with embodiments of the present disclosure.

FIG. 5 illustrates exemplary perspective and exploded views of retractable handle indicating its assembly and working details in accordance with an embodiment of the present disclosure.

FIG. 6 illustrates an exemplary perspective view showing assembly of back cover with main module in accordance with an embodiment of the present disclosure.

FIGS. 7A and 7B illustrate exemplary perspective views showing working and assembly of side cover lid with main module in accordance with an embodiment of the present disclosure.

FIG. 8 illustrates an exemplary perspective view showing assembly of weight sensor with main module in accordance with an embodiment of the present disclosure.

FIG. 9A to 9E illustrate exemplary perspective views showing assembly and working of retractable wheel module with main module in accordance with an embodiment of the present disclosure.

FIGS. 10A and 10B illustrate exemplary perspective view showing working and assembly of cup holder with main module in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

Unless the context requires otherwise, throughout the specification which follow, the word “comprise” and variations thereof, such as, “comprises” and “comprising” are to be construed in an open, inclusive sense that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable.

The recitation of ranges of values herein is merely intended to serve as a shorthand method of referring individually to each separate value falling within the range. Unless otherwise indicated herein, each individual value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

The headings and abstract of the invention provided herein are for convenience only and do not interpret the scope or meaning of the embodiments.

Various terms as used herein. To the extent a term used in a claim is not defined, it should be given the broadest definition persons in the pertinent art have given that term as reflected in printed publications and issued patents at the time of filing.

Reference will now be made in detail to the exemplary embodiments of the present disclosure, examples of which are illustrated in the accompanying drawings. Wherever possible, the same reference numbers are used in the drawings and the description to refer to the same or like parts.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

Embodiment described herein relate to a multifunctional smart luggage carrier that can meet multifaceted travelling needs of its user who may be travelling between locations for work and/or pleasure. The user may need different items during a travel. In an aspect the disclosed luggage carrier meets such requirements and many others that the user may need for convenient and comfort during the travel.

In an aspect, the proposed luggage carrier comprises a main module having a partition wall, the partition wall dividing the main module between a front side compartment and a back side compartment; a front cover fixed to the main module in hinged manner on the side of the front side compartment; and a back cover fixed to the main module in hinged manner on the side of the back side compartment. The disclosed luggage carrier also includes a plurality of retractable wheels that in their open condition support the luggage carrier and enable its movement. In an aspect, the luggage carrier further includes a wireless communication module to establish wireless communication with an external electronic device, wherein the wireless communication between the luggage carrier and the connected external device provides additional functionalities to the luggage carrier.

In an aspect, additional functionalities provided by the wireless communication is at least one of location tracking, automatic retraction and deployment of wheels, communicating weight of the luggage carrier, issuing a warning when distance between the luggage carrier and the external device exceeds a predefined limit, telescopic handle up down movements, operation of locks, LED lights ON and OFF.

In an aspect, external electronic device is any one of a smart mobile phone, a tablet or a desktop computing device or any other such device, and wherein the additional functionalities are made operational by syncing the luggage carrier with an application (hereinafter referred to as App) on the synced external electronic device.

In an aspect, the disclosed luggage carrier includes a microcontroller and associated electronic circuit that includes the wireless communication module, and wherein the microcontroller and the electronic circuit works to operationalize the various functionalities.

In an aspect, the disclosed luggage carrier further includes a power storage and supply system to meet power requirement of the microcontroller and the electronic circuit, and of different functional requirements; and wherein the power storage and supply system includes a rechargeable power bank or a storage battery, and further includes at least one USB port for getting input power for recharging the rechargeable power bank or the storage battery, and supplying power for charging of other electronic devices.

In an aspect, plurality of wheels are retractable within the luggage carrier to prevent damage due to rough handling, and the luggage carrier includes a motorized retraction mechanism coupled to the plurality of wheels to automatically retract them, and wherein the retraction mechanism is adapted for operation using the external electronic device. The motor of the motorized retraction mechanism for the retractable wheels gets electric power from the rechargeable power bank or the storage battery, and its operation command from the synced external electronic device through the electronic circuit.

In an aspect, luggage carrier includes a weight sensor fitted between the main module and a handle, and wherein weight of the luggage carrier as sensed by the weight sensor is displayed on a display on the main module, and in addition communicated to the external electronic device based on user choice.

In an aspect, luggage carrier includes a retractable handle and a motorized mechanism to move the retractable handle between a retracted position and an extended position, and wherein the motorized mechanism for the retractable handle is adapted for actuation using the synced external electronic device. The retractable handle can be located adjacent to the partition in the main module either in the front side compartment or the back side compartment to enable user to carry the luggage carrier from either side.

In an aspect, luggage carrier includes solenoid locks to lock the front cover and the back cover with the main module, and wherein the solenoid locks are adapted for operation through the synced external electronic device.

In an aspect, luggage carrier includes a location tracking module adapted to ascertain location coordinates of the luggage carrier based on a request from a user through the external electronic device, and wherein the ascertained location coordinates are communicated to the synced external electronic device using the communication module.

In an aspect, luggage carrier includes a proximity sensor adapted to sense distance between the luggage carrier and the synced external electronic device, and wherein in the event of the sensed distance exceeding a predefined distance a warning is issued.

In an aspect, the luggage carrier includes orientation sensors to sense orientation of the luggage carrier, wherein the orientation sensors are at least one of a magnetometer, an accelerometer and a gyroscope, and wherein the sensed orientation is displayed on the display or the synced external electronic device.

In an aspect, the luggage carrier further includes an atmospheric pressure sensor to sense the atmospheric pressure, wherein the sensed atmospheric pressure is used to ascertain altitude, and when the ascertained altitude is more than a first predefined value, it is ascertained that the luggage carrier is in a flight, and the electronic circuit is put to sleep mode to help conserve charge of the battery life. On the other hand, when the ascertained altitude is less than a second predefined value it is ascertained that the flight is landing, and the electronic circuit is put to active mode.

In an aspect, the front cover includes a switchable film (alternatively known as smart film) to enable viewing of contents within at least a part of the luggage carrier by making the switchable film transparent.

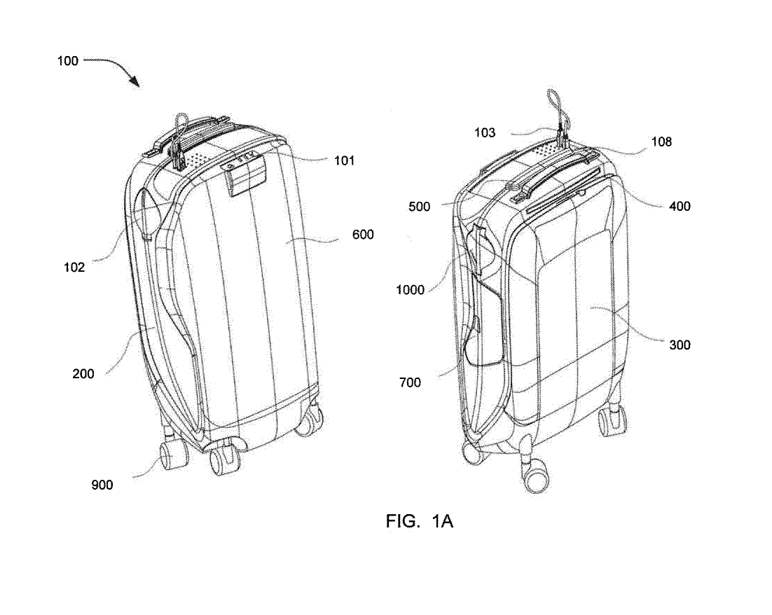

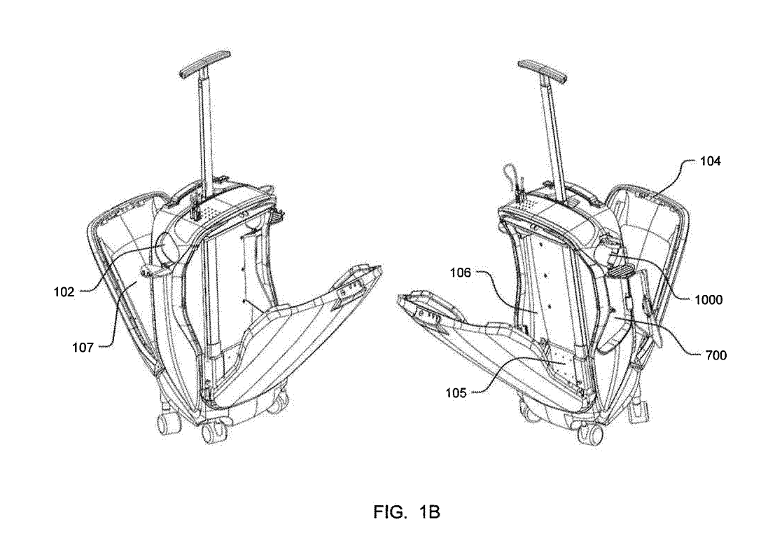

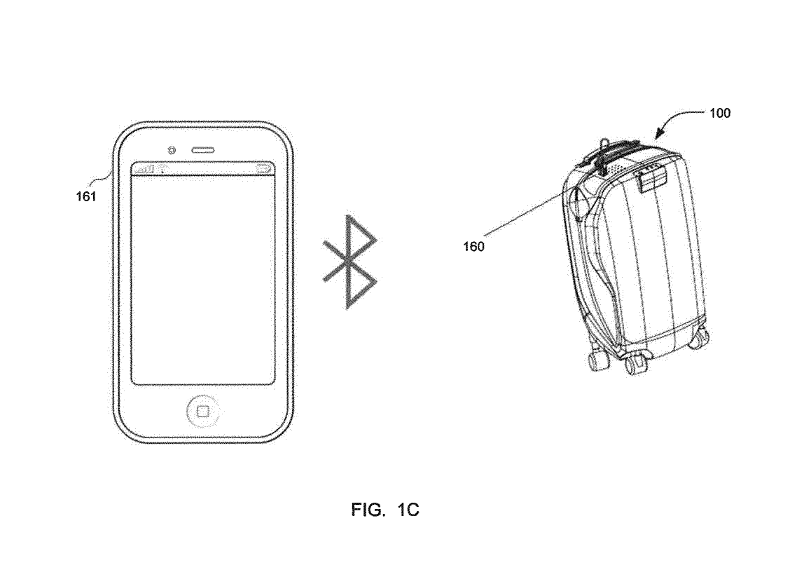

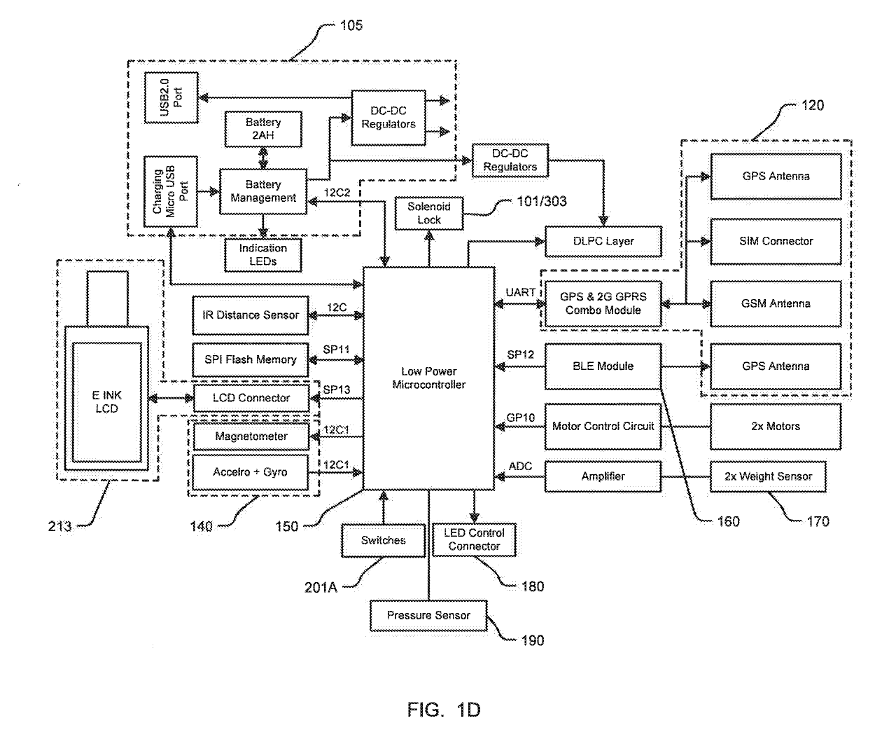

FIGS. 1A and 1B illustrate front and rear perspective views of the proposed smart luggage carrier in closed and open conditions. As shown, the luggage carrier 100 includes a front cover 300, back cover 600, main module 200 and retractable wheel assembly 900. Back cover 600 includes solenoid lock 101 for locking the back cover 600 with main module 200 in close condition. The solenoid lock 101 can be operated either manually or automatically using a mobile application.

Referring to FIG. 1A, main module 200 consists of handle 108 for lifting the luggage carrier 100, USB port 103 for providing power supply to internal and external devices, cup holding compartment 1000 for placing a tea, coffee or beverages cup or a container while travelling. It further includes a first side compartment 700 and a second side compartment 102 for placing and storing items that are frequently used during travel time, such as electronic device charger, sunglasses, grooming stuff, passport and personal documents, keys etc. Further included is an motorized retractable handle 500 which is configured with electronics and mobile application for automatic retracting the handle 500 as per user need. Also included are a laptop tray 400 for putting laptop and other stuff by sliding the tray 400 from main module 200, and retractable wheel assembly 900 for automatically retracting wheels from their retracted position within the main module 200, when required.

Referring to FIG. 1B, where front and rear perspectives views of luggage carrier 100 in open condition are shown. As shown therein, front cover 300, main module 200 and back cover 600 provide two internal compartments for placing various items like clothes, electronics items (for example laptop, tablets) etc. The front cover 300 in combination with the main module 200 can create a front side compartment 107, and the back cover 600 in combination with the main module 200 can create a back side compartment 106. The front cover 300 and the back cover 600 can be pivotally attached to the main module 200 by a hinged joint, and provided with solenoid operated locks. Power storage and supply system 105 can be fitted in inner side of the back side compartment 106 for providing power supply to both internal and external electronics devices.

As shown in FIG. 1B the retractable handle 500 can be located adjacent to the partition in the main module 200 either in the front side compartment 107 or the back side compartment 106 to enable user to carry the luggage carrier 100 from either side.

In an aspect of the present disclosure, the proposed luggage carrier 100 includes a communication module to establish wireless communication with an external device thereby making the luggage carrier 100 smart, wherein the wireless communication between the smart luggage carrier 100 and the connected external device can provide additional functionalities to the luggage carrier 100.

In an aspect, the additional functionalities provided in the proposed luggage carrier can be at least one of location tracking, automatic retraction and deployment of wheels, communicating weight of the luggage carrier, issuing a warning when distance between the luggage carrier and the external device exceeds a predefined limit, telescopic handle up down movements, operation of solenoid locks, LED lights on and off etc.

In an embodiment, wireless communication module 160 of the proposed luggage carrier 100 can be based on Bluetooth as shown in FIG. 1C, and can connect electronics component (described in subsequent paragraphs) of the luggage carrier 100 to an external electronic device 161. The external electronic device 161 can be for example, a smart phone, a tablet, a desktop or any other similar computing device that has matching capabilities. Various functionalities can be activated remotely from the external electronic device 161 using an application configured within the electronic device 161. The application can also be used to access and display various information/data pertaining to the luggage carrier 100 for benefit of user of the luggage carrier 100.

FIG. 1D illustrates an exemplary block diagram showing layout of electronics part of the disclosed smart luggage carrier 100. The electronics part includes power storage and supply system 105, location tracking module 120, display 130, orientation sensor 140, microcontroller 150, wireless communication/BLE module 160, weight sensor 170, LED control connector 180, solenoid locks 101 and 303 and pressure sensor 190. Power storage and supply system 105 includes input charging USB port for charging internal power storage, Power bank or battery storage for storing electric power and output port for charging external device (like laptop, mobile etc.). Location tracking module 120 is for tracking location of the luggage carrier 100 when it lost by any mistake. Location tracking module 120 comprises GPS Antenna and SIM connector in luggage carrier electronic circuit. Each time the user pings the microcontroller 150 through a mobile App, the microcontroller 150 requests latitude and longitude coordinates from the GPS (Global Positioning Sensor). The GPS receives the co-ordinates through GPS antennae and sends back the coordinates to the microcontroller 150, which in turn sends the location coordinates back to the App through GPRS module. A service provider SIM Card can be used to facilitate the GPRS module in sending the information over wireless network to the mobile App. LED or LCD or E INK display 213 is fitted in main module 200 of the luggage carrier 100 and connected with electronic circuit for displaying data and status of the luggage carrier 100. In addition, it can also display various features and other information like weight of carrier, location, weather data, flight information, boarding pass etc. Orientation sensors 140 can include sensors like magnetometer, accelerometer and gyroscope, and are provided in electronics circuit for sensing the orientation of luggage carrier, and the sensed orientation can be displayed in the display 213 or in the external device 161 (refer FIG. 1C) through the mobile App. The microcontroller 150 can be powered by 4-cell Lithium polymer battery. The battery can supply power to the electronic circuit through a DC regulator for providing constant voltage. The luggage carrier includes USB power ports to enable charging of any USB powered device drawing power from the same battery. The circuit incorporates a battery charger IC that charges Lithium battery as per safety standards.

In an aspect, wireless communication/BLE Module (Bluetooth low energy module) 160 enables controlling various features of the proposed luggage carrier 100 from an external/remote electronic device such as device 161 of FIG. 1C. Using the wireless communication/BLE Module 160 of the luggage carrier 100, major smart functions of the luggage carrier 100 can be controlled through a mobile App. The mobile App can be connected to the luggage carrier 100 through Bluetooth syncing. The luggage carrier 100 can be assigned with multiple users. After syncing the luggage carrier 100 with the mobile app of one user, the bag can be controlled only by owner of specific mobile App until the user logs out. The functions that can be controlled by the mobile App are—smart Lock, location tracking, telescopic handle up-down movements, automatic retractable wheels, weight display, LED lights on and off. Also, the app allows to deactivate peripherals thereby enabling a user to stop working of specific features thereby saving on battery. For example, weight of the luggage carrier 100, which is sensed by a weight sensor attached near handle of the luggage carrier, is displayed on the display screen integrated on the luggage carrier as well as on mobile App through Bluetooth connection. The user can request for display of weight through mobile App followed by lifting the luggage carrier using the handle and can disable this function after he has ascertained the weight to save battery life.

In an aspect, the disclosed luggage carrier 100 includes feature of automatically putting electronics of the luggage carrier to sleep mode when the luggage carrier is in flight. For this, a pressure sensor 190 is provided for sensing atmospheric pressure to ascertain altitude. The ascertained altitude can be used to identify that the luggage carrier is stowed in an airplane and would not be used until the altitude comes down. Thus, the ascertained altitude can be used to automatically switch-off the electronic system of the luggage carrier 100 to put it to sleep mode when the ascertained altitude is above a predefined limit, and switch-on to active mode when the ascertained altitude comes below a second predefined value that indicated that the flight has landed or about to land.

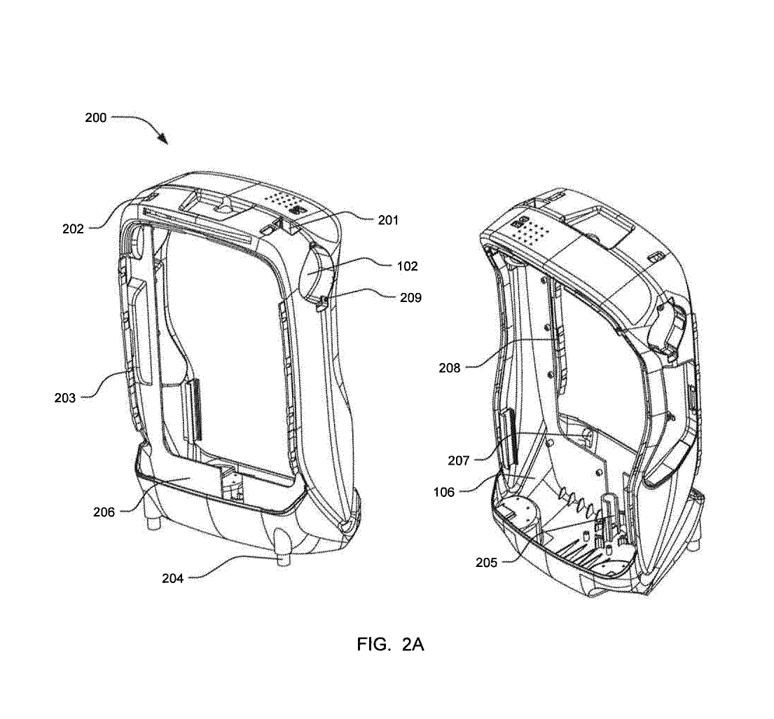

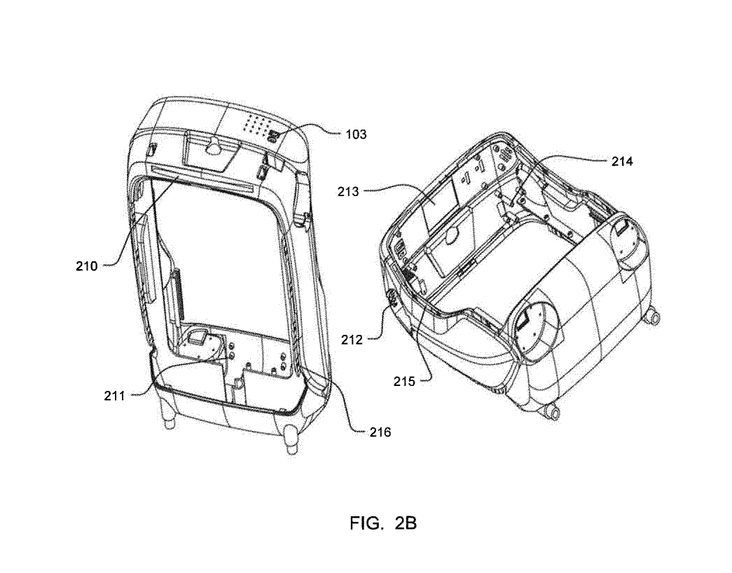

FIGS. 2A and 2B illustrate exemplary perspective views of main module of smart luggage carrier from different angles, where the main module 200 is made from a plastic material and incorporates two compartments—a front side compartment 107 and a back side compartment 106 (refer FIG. 1B). The front side compartment 107 and back side compartment 106 are separated by a partition wall in the main module 200. The main module 200 further includes power switch slot 201, handle slots 202, locators for front panel 203 for providing guidance during locking/closing of main module 200, wheel boss 204 for locking of wheel shaft with main module 200, motor mounting area 205, front door hinge boss 207, locators for back panel 208, hinge cut out for second side compartment lid, sliding tray compartment 210, locking boss for front cover hinge 211, female snap 212, LED screen 213, weight sensor holding bosses 214, female groove 215 and male protrude rib 216.

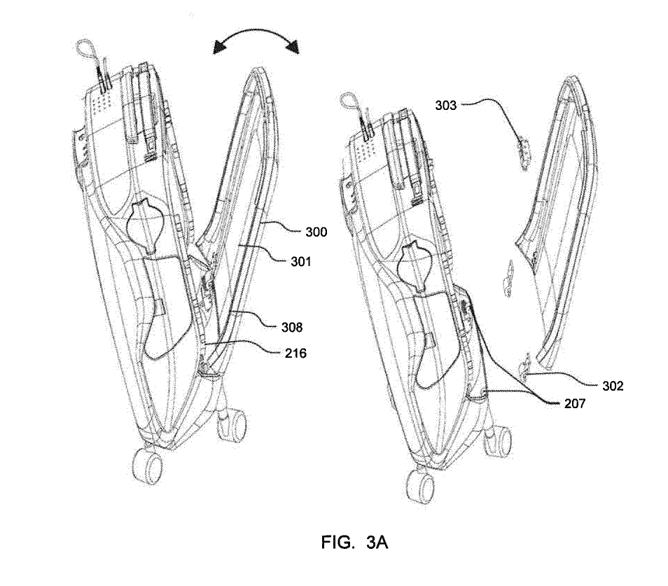

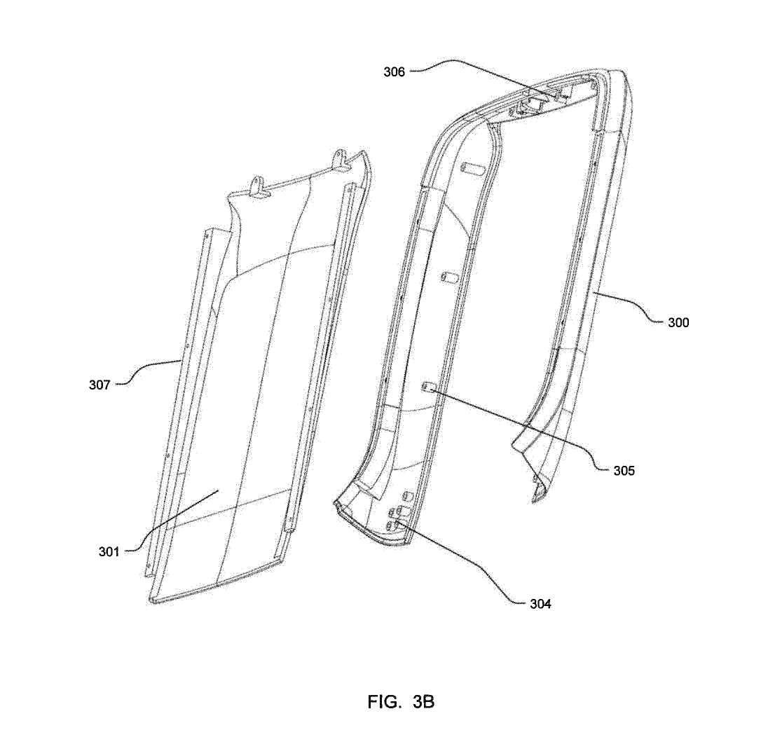

FIG. 3A illustrates an exemplary perspective and exploded views of the smart luggage carrier showing assembly of main module and front cover with PDLC film in accordance with an embodiment of the present disclosure. As shown, the front cover assembly includes front cover 300, PDLC film 301, front door hinge 302 and solenoid lock 303. The front cover 300 incorporates bosses for front cover hinge lock 304, bosses for PDLC film locking 305, female groove 308, wherein PDLC film 301 is fitted on front cover by screws through bosses 305. One face of hinge 302 is fitted on bosses for hinge lock 304 and other face of hinge 302 is fitted with front door hinge boss 207. Solenoid lock 303 is fitted on top side of the front cover 300 where bosses 306 are provided for screwing. PDLC film 301 is a film which can be automatically transformed from transparent state to an opaque translucent state with a simple flip of a switch. The switch can be electronically operated and connected to power source for getting input power. User can operate PDLC film using mobile App or manual switch which is provided on main module 200. The PDLC film 301 enables checking of interiors of the luggage carrier without having to open the luggage carrier. PDLC film 301 can be fixed to front cover 300 through side bracket 307. Front cover 300 is pivotally connected with main module 200 through the hinge 302 and can swing for opening and closing the main module 200. For proper locking with the main module 200, front cover 300 incorporates a female groove 308. When the door is closed male protrude rib 216 is guided and locks inside the female groove 308.

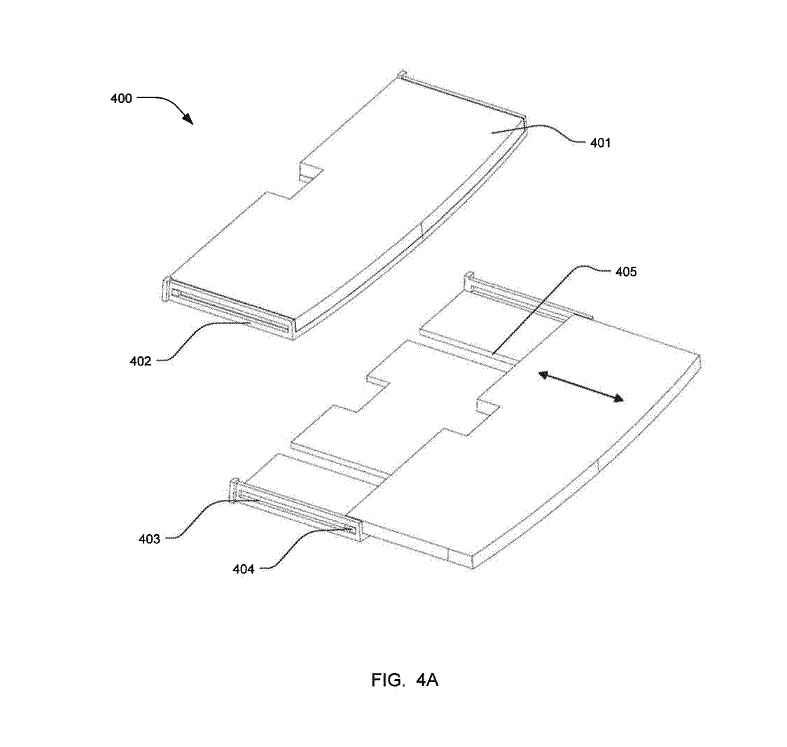

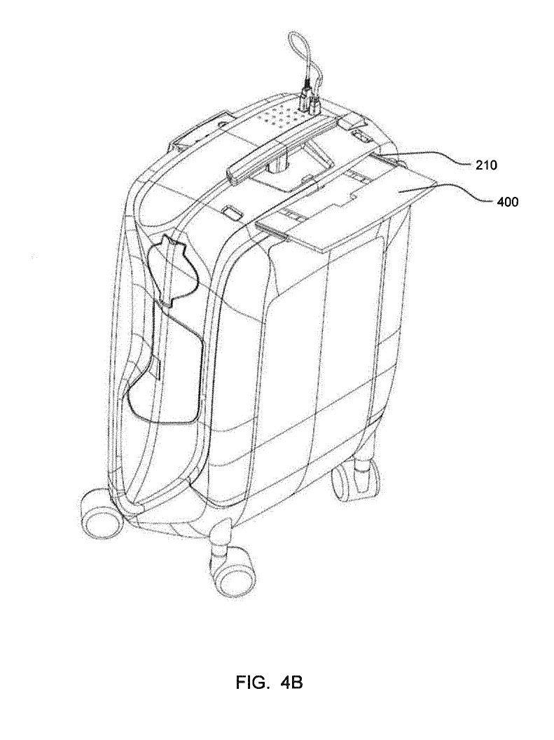

FIGS. 4A and 4B illustrate exemplary perspective views of a multipurpose foldable laptop tray assembly 400 and its assembly with main module 200 respectively, wherein the laptop tray assembly 400 constitutes two parts—top side tray 401 and bottom side tray 402. The top side tray 401 slides on the bottom side 402 tray based on a guiding mechanism, wherein the bottom side tray 402 incorporates tray guiding side slots 403 and tray guide bottom slot 405, and top tray 401 incorporates tray guide boss 404. The tray guide boss 404 in the top tray 401 is guided in inner side of tray guiding side slots 403 for forward and backward movement of the trays during working. Tray assembly 400 is fitted inside the laptop sliding tray compartment 210 of main module 200. Both the trays are made from plastic, sheet metal and nylon material integration for easy and jerk free use. The multipurpose foldable laptop tray assembly 400 can be used as a laptop workstation or for placing snacks, beverages or any other thing whenever such need arises during travel.

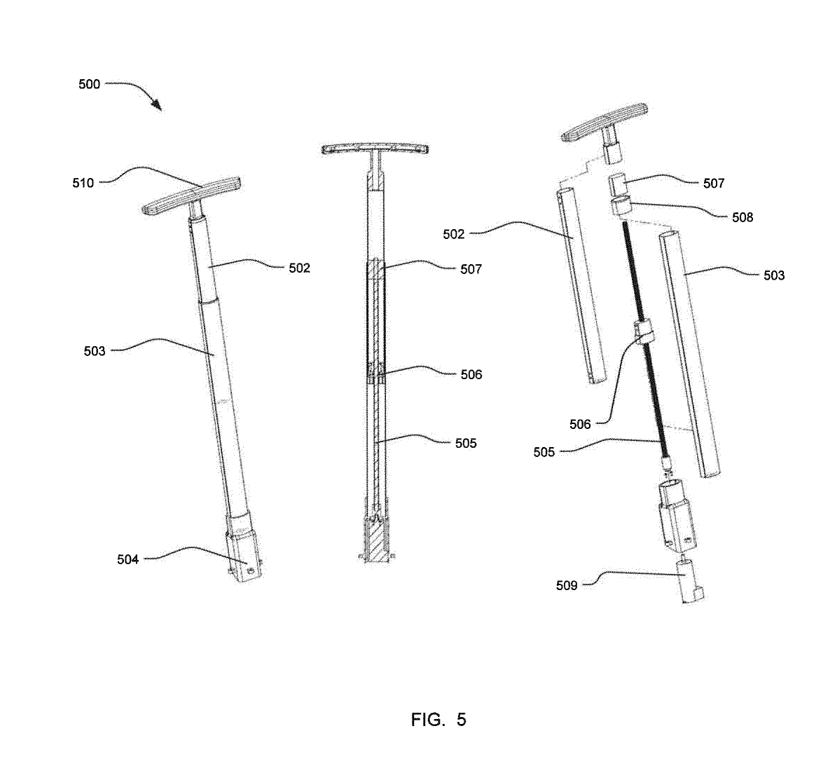

FIG. 5 illustrates exemplary perspective and exploded views of retractable handle indicating its assembly, wherein the retractable telescopic handle 500 comprises top handle 501, inner tube 502, outer tube 503, motor cover 504, lead screw 505, sliding nut 506, end stopper 507 and motor 509. The top handle 501 is fitted inside the inner tube 502 of telescopic handle, sliding nut 506 is fitted in bottom inner side of the inner tube 502 and incorporates threads/grooves in its center for engagement with the lead screw 505. Plastic cover 508 is fitted on top inner side of the outer tube 503 which restricts extension or retraction of the inner tube to its extreme position during working. The end stopper 507 is firmly gripped at one end of the lead screw 505 and provides stability and reduces wobbling of lead screw 505 during working on account of its excess length. Second end of lead screw 505 is locked with the motor 509 and the motor 509 is covered by motor cover 504 and is connected with the electronic circuit for input power. In exemplary condition, when user wants to use automatic retractable handle, he needs to give a signal, by any of the provided means, i.e. through mobile App or manual button, to the electronic system. On being actuated, the electronics system supplies power to the motor, which starts rotating in clockwise direction. Rotation of the motor is converted by the lead screw to a linear motion of the sliding nut. The sliding nut is connected to the inner tube, and therefore, forces the inner tube to move forward to result in automatic retraction of the handle. Similarly, for closing the handle, motor moves anti-clock wise to return the whole mechanism back to its original position. Speed of the motor 509 and extent of its rotary movement can be controlled by electronic system.

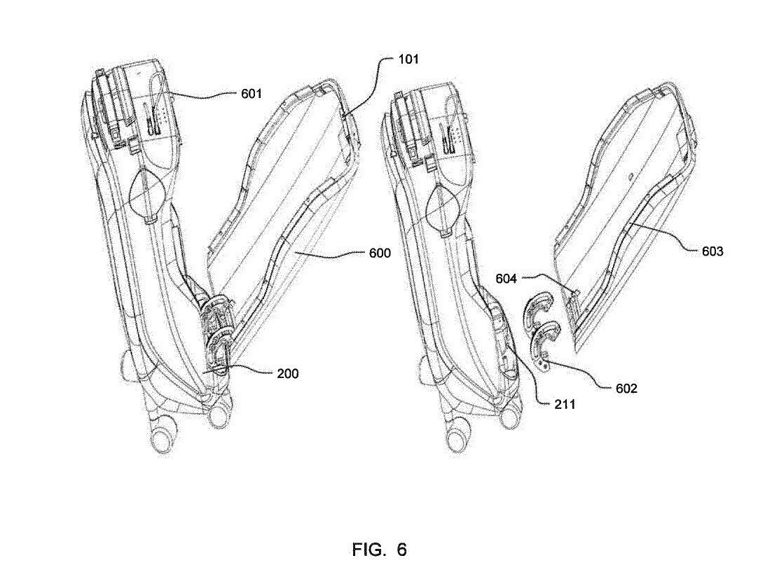

FIG. 6 illustrates an exemplary perspective view showing assembly of back cover 600 with main module 200 in accordance with an embodiment of the present disclosure. Shown therein is solenoid lock 101 fitted to back cover 600 for locking it with main module 200. The back cover 600 is pivotally attached to the main module 200 through metal hinge 602. The back cover 600 incorporates a male protruded rib 603 that securely locks and fits with corresponding feature on the main module 200. The back cover 600 also includes locking boss for front cover hinge 211 and hinge bosses 604 for locating and fitting of metal hinge 602. One end of the metal hinge 602 is locked at the locking boss 211 and other end is fitted with the hinge bosses 604. The metal hinge 602 enables the back cover 600 to open up-to 180 degrees from the main module 200 and enables the back cover 600 to be held at any angle as per user need.

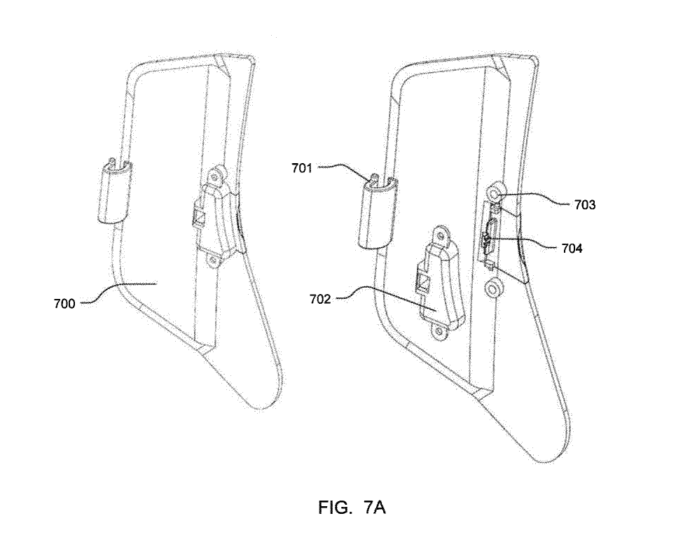

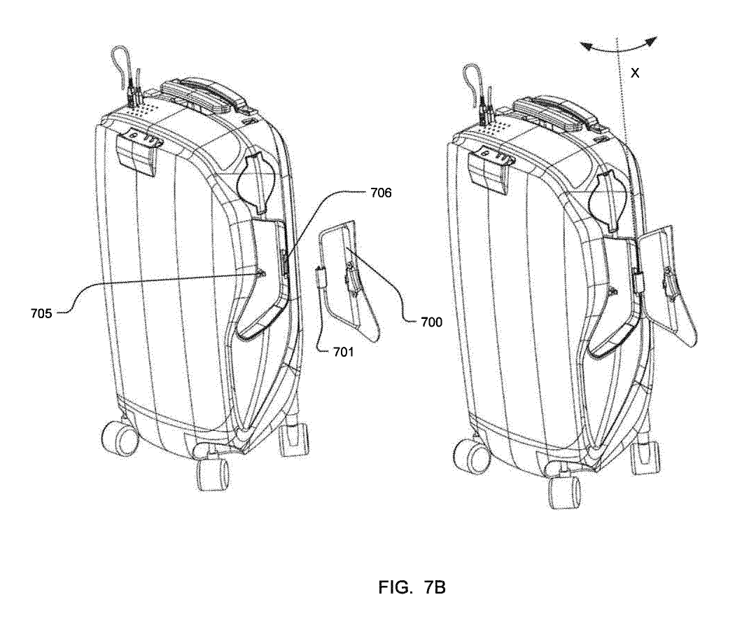

FIGS. 7A and 7B illustrate exemplary perspective views showing working and assembly of side compartment cover with main module. As shown, the first side compartment cover 700 is an external lid used for covering the open space of first side compartment. The side compartment cover 700 incorporates a male cylindrical hinge 701, top cover for lid lock 702, screw boss 703 for lid lock, and male snap 704 for locking with main module 200. The side compartment cover 700 is pivotally joined with the main module 200 through a female cylindrical hinge 706. In locked condition, the male snap 704 of the side compartment cover 700 positively locks with the male snap 705 of main module 200. The side compartment cover 700 can swing about X-axis and open to more than 90 degrees in relation with the main module 200.

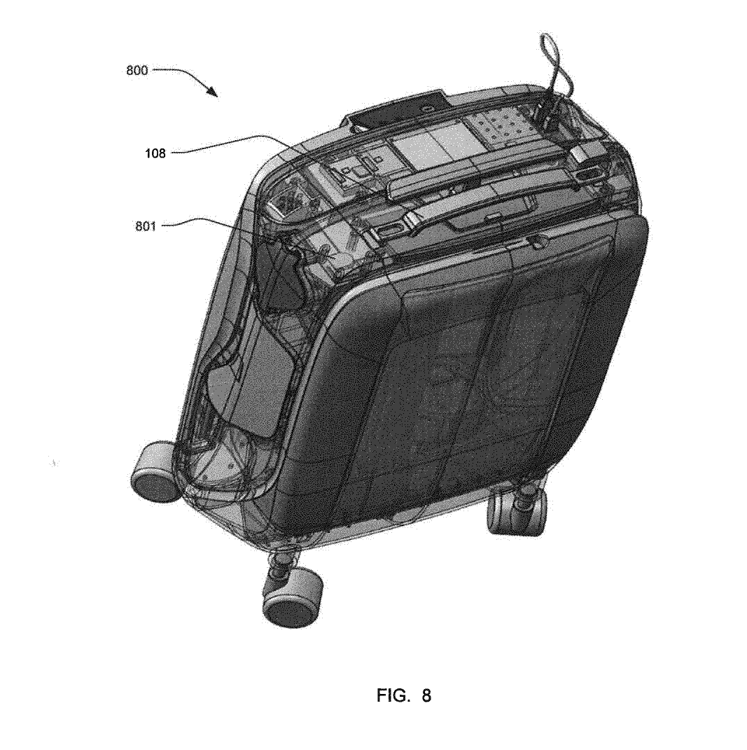

FIG. 8 illustrates an exemplary perspective view showing assembly of weight sensor with main module in accordance with an embodiment of the present disclosure. The weight sensor 801 is firmly fitted to main module 200 on bosses 214, and is connected with handle 108 for checking overall weight of the luggage carrier 100. When user wants to check weight of the luggage carrier after packing, he needs to raise/lift the luggage carrier 100 through the handle 108. The weight sensor 801 is connected to electronic circuit for input power and transferring weight data to display 213 or mobile App for user.

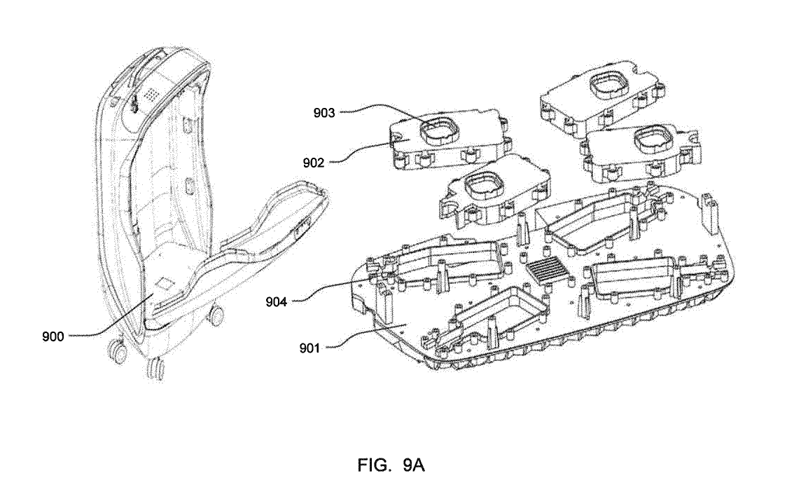

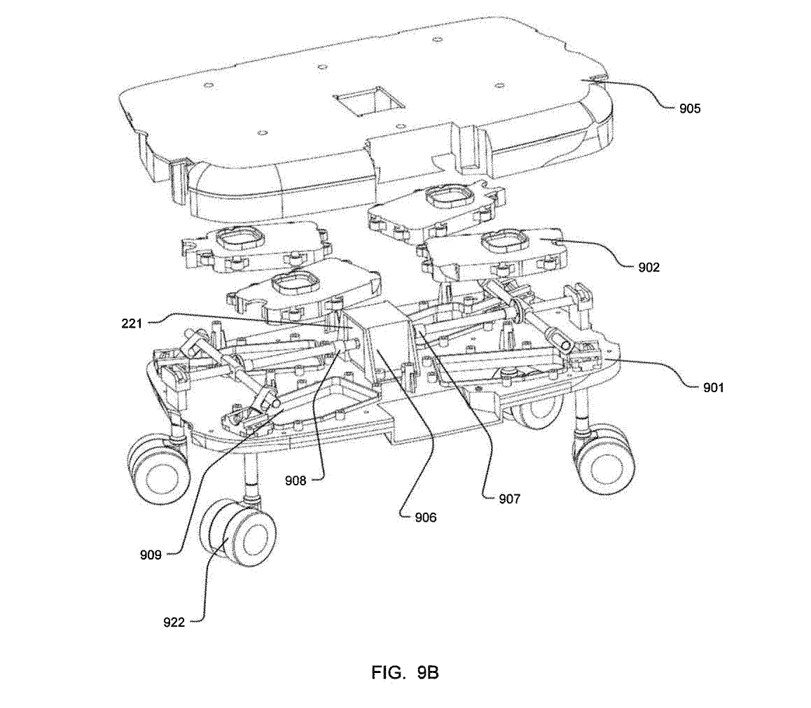

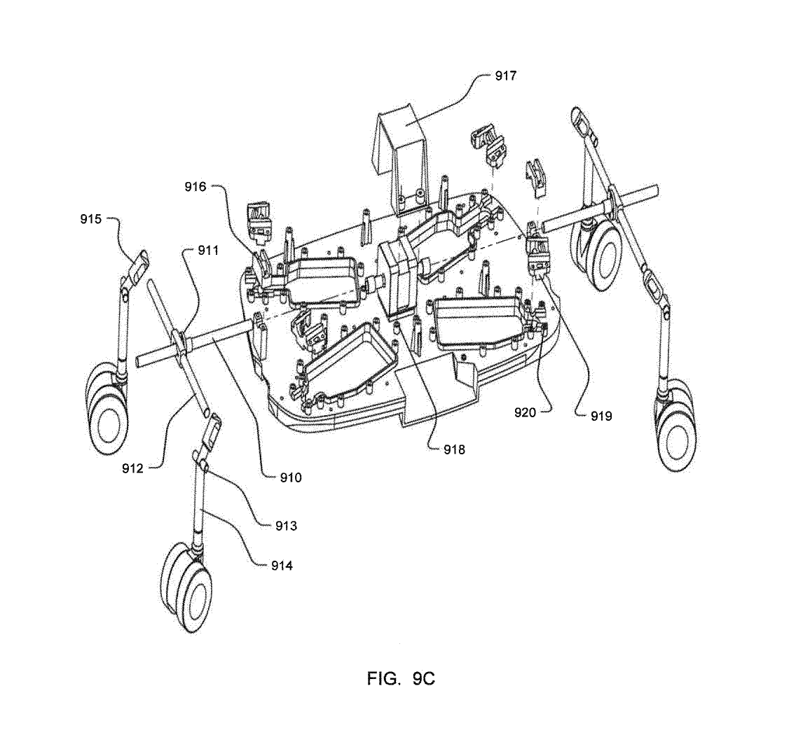

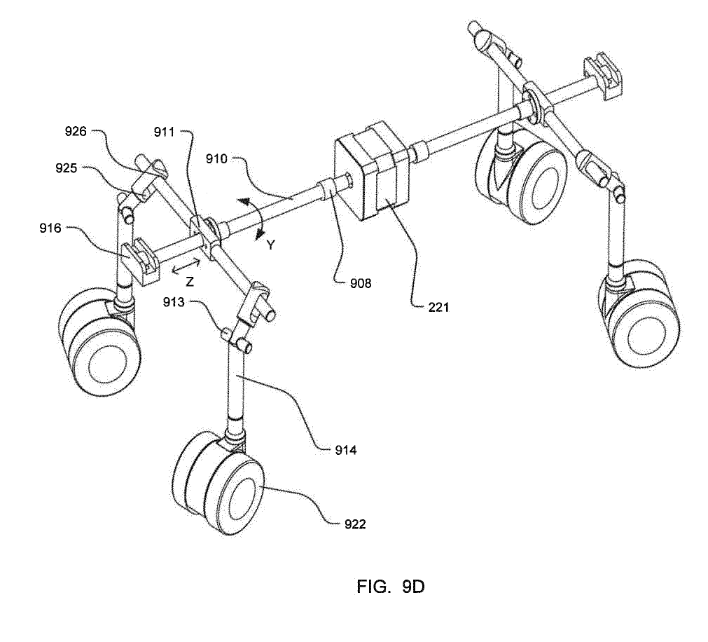

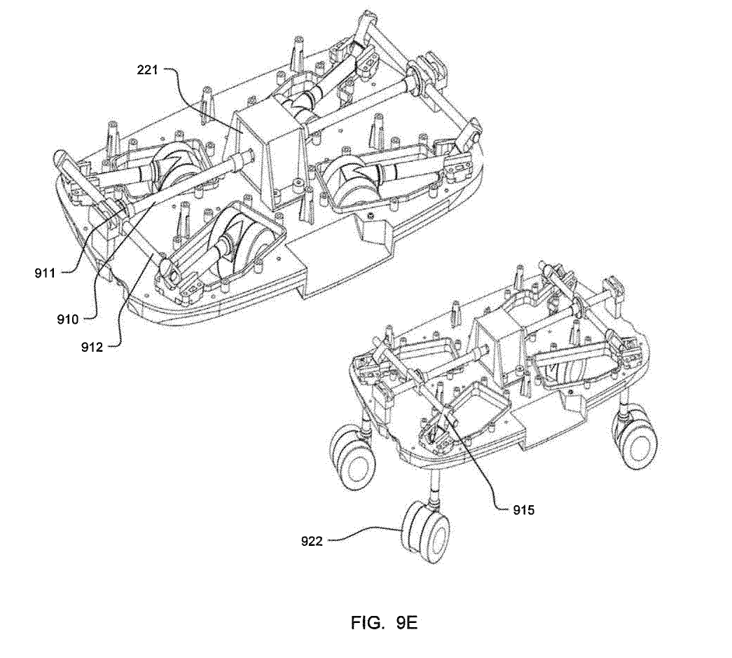

FIG. 9A to 9E illustrate exemplary perspective views showing assembly and working of retractable wheel module with main module wherein FIG. 9A is perspective view showing retractable wheel compartment 900 and associated parts for assembly of retractable wheels with main module 200. The retractable wheel compartment 900 is located on bottom side of the luggage carrier, where a base plate 901 for wheel assembly provides main support and structural rigidity to whole system. On top side of the base plate 901 four wheel openings 909 are provided for four wheels, and four individual wheel covers 902 are fitted on these openings using locators and clamping boss 904.

FIG. 9B illustrates an exploded view of retractable wheel assembly 900 showing the base plate 901 covered with a top plate 905 after assembly. As shown the retractable wheel assembly 900 includes the base plate 901, wheel covers 902, the top cover 905, motor cover 906, motor lead screw brackets 907 and 908. The top plate 905 covers the whole wheel assembly 900. The wheel openings 909 are sized to provide space for wheels 922 resting in retracted condition. The electric motor 221 is provide in center of the base plate 901 for mechanized retraction, and opening of wheels 922 to bring them to working condition, wherein motor is securely covered with motor cover 906. Motor lead screw brackets 907 and 908 are connected at two ends of motor's shaft for extend the motor shaft and provide function of lead screws for opening and retracting the wheels.

FIG. 9C illustrates an exploded view of retractable wheel assembly 900. As shown therein, lead screw holder 916, motor cover 917, wheel hinge holder 919 are fitted on base plate 901. Motor cover 917 fits on mounting boss 918 of base plate 901 and securely grip the motor in center of base plate 901. This assembly includes left side lead screw 910, left side sliding nut 911, left side horizontal shaft 912, wheel rotating hinge 913, wheel vertical shaft 914 and wheel inclined shaft 915. One end of the left side lead screw 910 works as a power transmitting shaft and incorporates helical grooves to transmitting power for wheel retraction. It is connected with motor lead screw bracket 908, and its other end rests inside the bearing (not shown in figures) on base plate and 901 covered with lead screw holder 916. Left side sliding nut 911 is fitted with left side horizontal shaft 912 using screws and guided on the lead screw. The left side sliding nut 911 also incorporates an inner helical groove which engages with lead screw thereby converting rotary motion of shaft to linear motion of left side horizontal shaft 912. Wheel inclined shaft 915 and wheel vertical shaft 914 are joined with each other at horizontal wheel rotating hinge 913. Wheel inclined shaft incorporates elongated slots for the horizontal shaft movement 912 to engage in and impart movement to the wheel inclined shafts 915 on either side. Mechanism on other side is configured in same manner to provide retraction/opening movement to other two wheels.

FIGS. 9D and 9E illustrate working of retractable wheel assembly 900 in open and closed condition. Motor 221 is connected to the electronics circuits for getting power and commands for an operation. As the motor 221 rotates in clockwise direction (as shown by Y), left side sliding nut 911 moves linearly in Z direction due to its engagement with the left side lead screw 910. Initially the wheels may be in open condition and in this situation, left side horizontal shaft 912 shall be located towards bottom side (shown as 925) of slot. When the left side sliding nut 911 moves linearly in Z direction i.e. towards left side, the horizontal shaft 912 shall move to top position (shown as 926) in the slots. Such movement would force the vertical shaft 914 to move in clockwise direction about wheel rotating hinge 913 resulting in wheel to move to their closing position and securely positioned within the respective wheel openings 909. During opening of the wheels from the retracted position mechanism operates in reverse manner in same fashion with the motor 221 rotating in anti-clockwise direction.

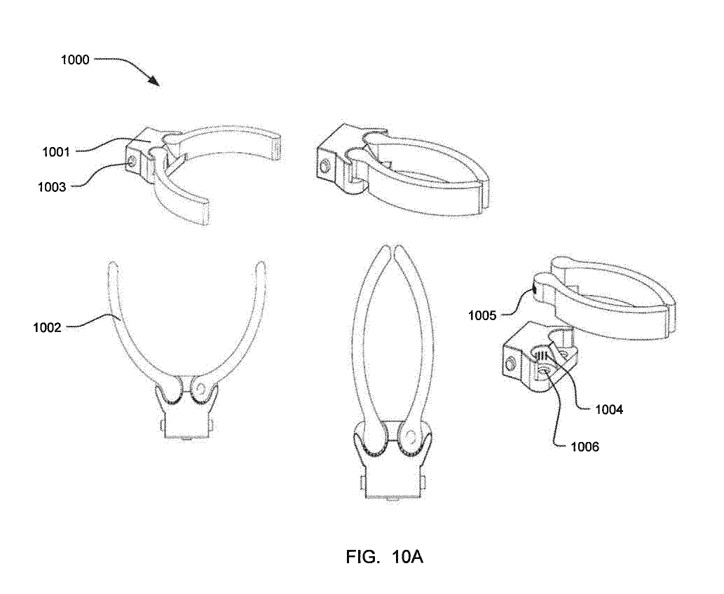

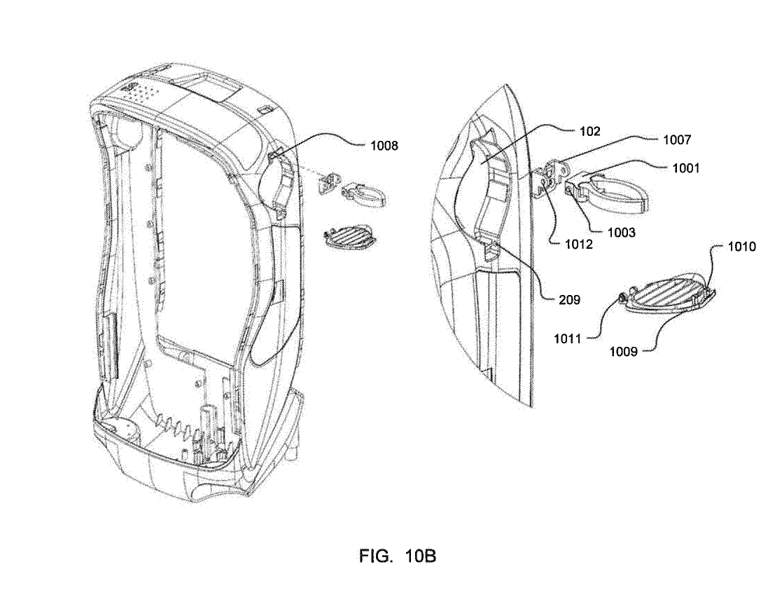

FIGS. 10A & 10B illustrate exemplary perspective views showing working and assembly of cup holder in cup holder compartment of main module. As shown, the cup holder 1000 includes bracket 1001, cup holding legs 1002, bracket holder 1007 and outer cover lid 1009. The cup holding legs 1002 are fitted with bracket 1001 and can swing about leg hinge points 1006. The cup holding legs 1002 can swing for an angle up to 90 degrees from their original position. Further, they can be locked at any required position using angle locking details 1004 which is provided in the bracket 1001 and angle locking details 1005 provided at one end of the cup holding legs 1002 that is fitted in the bracket 1001.

FIG. 10 B illustrates cup holder compartment assembly, wherein bracket holder 1007 is fitted at locking boss 1008. Bracket hinge 1003 is attached with hinge hole 1012 for swing. Outer cover lid 1009 is used for covering and closing the second side compartment 102. Hinge pin 1011 of outer cover lid 1009 is fitted in hinge cut out 209 and allows the outer cover lid 1009 to swing for opening and closing. It can swing up to 90 degrees.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Invention

The present disclosure provides a smart, durable, automatic, multifunctional, reliable & user-friendly luggage carrier.

The present disclosure provides a luggage carrier having automatic retractable wheels, telescopic handle & automatic lifting mechanism for user comfort.

The present disclosure provides a luggage carrier that integrates smart systems like in built weigh scale, a virtual tag or display, luggage tracking system, remotely lock & unlock arrangement and proximity indication.

The present disclosure provides a radio frequency identification enabled pocket for holding personal items, such as passport and credit cards, which blocks any potential identity theft.

The present disclosure provides a feature for LED light system that lights up interior or exterior of the suitcase or luggage carrier.

The present disclosure provides an in-built power storage & power supply system for charging external & internal electronic devices.

The present disclosure provides a smart system which enables user to switch the mode of operation like manual mode (sleep mode) to automatic mode & vice versa.

We claim:

1. A smart luggage carrier comprising:
a main module having a partition wall, the partition wall dividing the main module between a front side compartment and a back-side compartment;
a front cover fixed to the main module in hinged manner on the side of the front side compartment; and
and a back cover fixed to the main module in hinged manner on the side of the back-side compartment;
a plurality of wheels that support the luggage carrier and enable movement of the luggage carrier;
wherein the luggage carrier further includes a wireless communication module to establish wireless communication with an external electronic device; and
wherein the wireless communication between the luggage carrier and the connected external device provides additional functionalities to the luggage carrier.

2. The luggage carrier as claimed in claim 1, wherein the external electronic device is any one of a smart mobile phone, a tablet or a desk top computing device, and wherein the additional functionalities are made operational by syncing the luggage carrier with an application on the external electronic device.

3. The luggage carrier as claimed in claim 2, wherein the additional functionality provided by the wireless communication is at least one of location tracking, automatic retraction and deployment of wheels, communicating weight of the luggage carrier, issuing a warning when distance between the luggage carrier and the external device exceeds a predefined limit, telescopic handle up down movements, operation of locks, LED lights ON and OFF.

4. The luggage carrier as claimed in claim 3, wherein the luggage carrier includes a microcontroller and associated electronic circuit that includes the wireless communication module, and wherein the microcontroller and the electronic circuit works to operationalize the various functionalities.

5. The luggage carrier as claimed in claim 4, wherein the luggage carrier further includes a power storage and supply system to meet power requirement of the microcontroller and the electronic circuit, and of different functional requirements; and wherein the power storage and supply system includes a rechargeable power bank or a storage battery, and further includes at least one USB port for getting input power for recharging the rechargeable power bank or the storage battery, and supplying power for charging of other electronic devices.

6. The luggage carrier as claimed in claim 5, wherein the plurality of wheels are retractable within the luggage carrier to prevent damage due to rough handling, and the luggage carrier includes a motorized retraction mechanism coupled to the plurality of wheels to automatically retract them, and wherein the retraction mechanism is adapted for operation using the external electronic device.

7. The luggage carrier as claimed in claim 6, wherein a motor of the motorized retraction mechanism for the retractable wheels gets electric power from the rechargeable power bank or the storage battery, and its operation command from the synced external electronic device through the electronic circuit.

8. The luggage carrier as claimed in claim 3, wherein the luggage carrier includes a weight sensor fitted between the main module and a handle, and wherein weight of the luggage carrier as sensed by the weight sensor is displayed on a display on the main module, and in addition communicated to the external electronic device based on user choice.

9. The luggage carrier as claimed in claim 3, wherein the luggage carrier includes a retractable handle and a motorized mechanism to move the retractable handle between a retracted position and an extended position, and wherein the motorized mechanism for the retractable handle is adapted for actuation using the external electronic device.

10. The luggage carrier as claimed in claim 9, wherein the retractable handle is located adjacent to the partition either in the front side compartment or the back side compartment to enable user to carry the luggage carrier from either side.

11. The luggage carrier as claimed in claim 3, wherein the luggage carrier includes solenoid locks to lock the front cover and the back cover with the main module, and wherein the solenoid locks are adapted for operation through the external electronic device.

12. The luggage carrier as claimed in claim 3, wherein the luggage carrier includes a location tracking module adapted to ascertain location coordinates of the luggage carrier based on a request from a user through the external electronic device, and wherein the ascertained location coordinates are communicated to the external electronic device using the communication module.

13. The luggage carrier as claimed in claim 3, wherein the luggage carrier includes a proximity sensor adapted to sense distance between the luggage carrier and the external electronic device, and wherein in the event of the sensed distance exceeding a predefined distance a warning is issued.

14. The luggage carrier as claimed in claim 3, wherein the luggage carrier includes orientation sensors to sense orientation of the luggage carrier, wherein the orientation sensors are at least one of a magnetometer, an accelerometer and a gyroscope, and wherein the sensed orientation is displayed on the display or the external electronic device.

15. The luggage carrier as claimed in claim 5, wherein the luggage carrier further includes an atmospheric pressure sensor to sense the atmospheric pressure, wherein the sensed atmospheric pressure is used to ascertain altitude and when the ascertained altitude is more than a first predefined value it is ascertained that the luggage carrier is in a flight, and the electronic circuit is put to sleep mode.

16. The luggage carrier as claimed in claim 15, wherein when the ascertained altitude is less than a second predefined value it is ascertained that the flight is landing, and the electronic circuit is put to active mode.

17. The luggage carrier as claimed in claim 1, wherein the front cover includes a switchable film to enable viewing of contents within at least a part of the luggage carrier by making the switchable film transparent.

18. The luggage carrier as claimed in claim 1, where the luggage carrier includes a multipurpose foldable laptop tray assembly fixed to the main module.
